(19) United States
(12) Patent Application Publication
(10) Pub. No.: US 2026/0010023 A1
(43) Pub. Date: Jan. 8, 2026

(54) SLOT MODULATORS WITH IMPROVED RF AND BANDWIDTH PERFORMANCE

(71) Applicant: Lightwave Logic Inc., Englewood, CO (US)

(72) Inventors: Michael Lebby, San Francisco, CA (US); Felipe Lorenzo Della Lucia, Paulinia (BR)

(73) Assignee: Lightwave Logic Inc., Englewood, CO (US)

(21) Appl. No.: 19/328,719

(22) Filed: Sep. 15, 2025

Related U.S. Application Data
(62) Division of application No. 17/688,474, filed on Mar. 7, 2022.

(51) Int. Cl. G02F 1/025; G02F 1/1334; G02F 1/21; G02F 1/225

(52) U.S. Cl. CPC G02F 1/025; G02F 1/1334; G02F 1/212; G02F 1/225; G02F 1/2257

(57) ABSTRACT

A slot modulator coupled to a coplanar transmission line, the slot modulator includes a pair of spaced apart rails forming a waveguide slot therebetween and opposed slabs coupling the rails to the coplanar transmission line, the rails are at least partially formed of highly doped silicon and the slabs are formed at least partially of highly doped silicon.

### FIELD OF THE INVENTION

This invention relates to slot modulators and more specifically to slot modulators with improved and bandwidth performance.

### BACKGROUND OF THE INVENTION

Slot modulators are well known in the art. Generally, a Mach-Zehnder type of modulator is provided by placing two slot waveguides in parallel and driving them in push-pull with a single coplanar transmission line. Generally, the slot waveguides used are standard of-the-shelf items and the rf and bandwidth performance is less than ideal. Also, connections to the chip are important because rf pads (w/wire bonding) must be close to the chip edges to maintain a reasonable rf performance.

It would be highly advantageous, therefore, to remedy the foregoing and other deficiencies inherent in the prior art.

Accordingly, it is an object of the present invention to provide new and improved slot modulators.

It is another object of the present invention to provide new and improved slot modulators with improved RF and bandwidth performance.

It is another object of the present invention to provide new and improved slot modulators in a Mach-Zehnder configuration with improved rf and bandwidth performance.

### SUMMARY OF THE INVENTION

To achieve the desired objects and advantages of the present invention a slot modulator coupled to a coplanar transmission line is disclosed. The slot modulator includes a pair of spaced apart rails forming a waveguide slot therebetween and opposed slabs coupling the rails to the coplanar transmission line. The rails are formed of highly doped silicon and the slabs are formed at least partially of highly doped silicon.

To further achieve the desired objects and advantages of the present invention a Mach-Zehnder slot modulator coupled to a coplanar transmission line is disclosed. The Mach-Zehnder slot modulator including a substrate with a coplanar transmission line positioned on the substrate and including first and second spaced apart elongated conductors with a third elongated conductor positioned midway between the first and second conductors. A first pair of spaced apart rails is positioned on the substrate between the first elongated conductor and the third elongated conductor and a second pair of spaced apart rails is positioned on the substrate between the second elongated conductor and the third elongated conductor. The first and second pairs of spaced apart rails each forming an elongated waveguide slot therebetween. The rails are formed of highly doped silicon. Opposed slabs are positioned on the substrate coupling the first and second pairs of rails to the elongated conductors of the coplanar transmission line. The slabs are formed at least partially of highly doped silicon. EO polymer cladding material is deposited over the first and second pairs of spaced apart rails and the slabs between the elongated conductors and in the waveguide slots.

To further achieve the desired objects and advantages of the present invention a specific embodiment of a method of fabricating a slot modulator coupled to a coplanar transmission line is disclosed. The method includes the steps of providing a substrate with the coplanar transmission line thereon, the coplanar transmission line including at least one pair of spaced apart conductors. The method further includes the steps of forming a pair of spaced apart elongated rails on the substrate between the pair of spaced apart conductors, the spaced apart rails defining an elongated waveguide slot therebetween, the rails being formed of highly doped silicon, forming opposed slabs on the substrate coupling the rails to the spaced apart conductors of the coplanar transmission line, the slabs being formed at least partially of highly doped silicon, and depositing an EO polymer cladding layer over the slabs and rails and in the waveguide slot. The method further includes a step of encapsulating the polymer cladding layer with a passivation layer which is preferably deposited by atomic layer deposition.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is an end view of a slot modulator with highly doped silicon slab and rail;

FIG. 2 is an end view of a slot modulator with a portion of the slab formed of highly doped silicon;

FIG. 3 is an end view of a slot modulator with the slab including a layer of highly doped silicon on metal;

FIG. 4 is an end view of a slot modulator with the slab having a metal profile shaped with highly doped silicon;

FIG. 5 is an end view of a slot modulator with modulation doping of the rails;

FIG. 6 is an end view of a slot modulator with a portion of the slab formed of highly doped silicon and modulation doping of the rails;

FIG. 7 is an end view of a slot modulator with the slab having a metal profile shaped with highly doped silicon and modulation doping of the rails;

FIG. 8 is an end view of a slot modulator with the slab having a metal profile shaped with highly doped silicon and modulation doping of the rails the slab having a metal profile shaped with highly doped silicon and varying doping of the rails;

FIG. 9A is a top plan view of a plurality of slot modulators formed in parallel on a chip and mounted on a printed circuit board, including wire bonds;

FIG. 9B is a top perspective view of the slot modulators formed in parallel on a chip and mounted on a printed circuit board with a flip-chip replacing the wire bonding; and

FIG. 10 is an end view of a slot modulator with a protection layer covering the EO material.

### DETAILED DESCRIPTION OF THE DRAWINGS

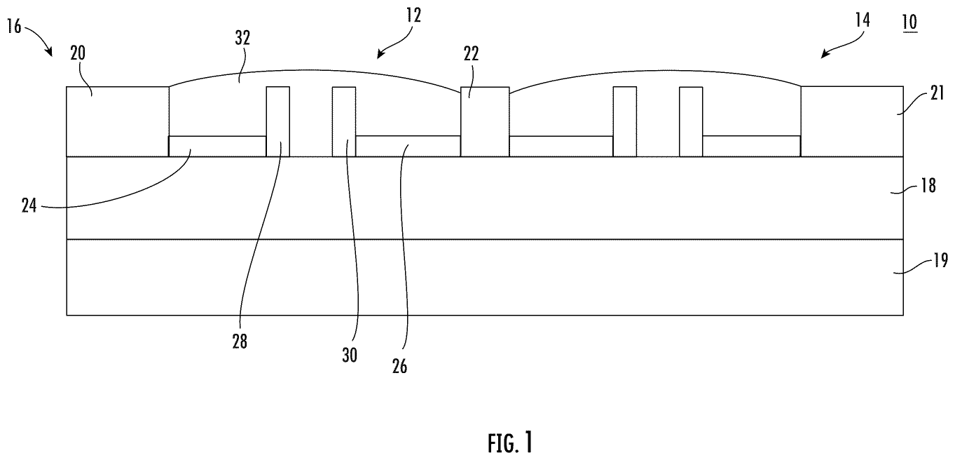

Basically, the invention consists of a variety of changes or modifications to the slab and rails of slot modulators to improve both rf performance and bandwidth. The various changes or modifications can be included individually or in any convenient and workable combination. Some examples of changes or modifications that can be incorporated are illustrated and described below in conjunction with FIGS. 1 through 8.

Referring specifically to FIG. 1, an end view of a slot modulator 10 is illustrated which in this example is a Mach-Zehnder modulator including two slot waveguides 12 and 14 in parallel and driven in push-pull with a single coplanar transmission line 16. It should be understood that a single slot waveguide can be used to form a slot modulator in accordance with the present invention. In this example, a typical SiO₂ box 18 is formed on a silicon substrate 19. Transmission line 16 is formed of spaced apart aluminum conductors positioned on SiO₂ box 18 with G conductors 20 and 21 on each edge and an S conductor 22 extending midway therebetween. Slot waveguide 12 includes a slab 24 extending inwardly from G conductor 20 and a slab 26 extending inwardly from S conductor 22. A vertically extending rail 28 is attached to the inner end of slab 24 and a vertically extending rail 30, spaced from rail 28, is attached to the inner end of slab 26. Rails 28 and 30 primarily form slot waveguide 12. The area between G conductor 20 and S conductor 22, including the slot formed between rails 28 and 30, is filled with EO polymer cladding material 32. Slot waveguide 14 is a mirror image of slot waveguide 12 with slabs and rails positioned and connected as described in conjunction with slot waveguide 12. In the following disclosure, only slot waveguide 12 is discussed in detail with the understanding that all of the details apply similarly to slot waveguide 14.

To aid in understanding the size of the structure being discussed, the thickness of transmission line 16 is 1 μm, slabs 24 and 26 are each 70 nm tall and 0.5 to 1 μm wide. Rails 28 and 30 are each 220 nm tall (lower surface to upper end) and 240 nm wide with a 200 nm spacing between the centers. The total length of slot waveguide 12 from G conductor 20 to S conductor 22 is 10 μm long.

In the prior art, slab 24 and rail 28 are integrally formed and also integrally formed with G conductor 20. Similarly, slab 26 and rail 30 are integrally formed and also integrally formed with S conductor 22. In a similar fashion, the slabs and rails of slot waveguide 14 are integrally formed with G conductor 21 and S conductor 22. In slot modulator 10 slabs 24 and 26 and rails 28 and 30 are formed of silicon that is highly doped (N⁺⁺⁺), to reduce resistivity and to achieve a high bandwidth.

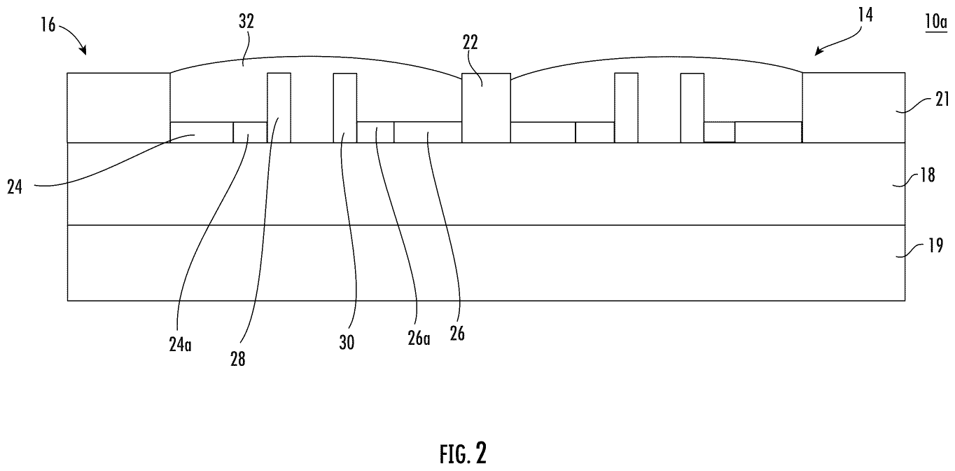

Turning to FIG. 2, a slot modulator 10a is illustrated in which slabs 24 and 26 are only partially replaced with highly doped silicon. That is a portion of each slab 24 and 26, generally less than half, adjacent to rails 28 and 30 is replaced with a highly doped portion of silicon, designated 24a and 26a, respectively. The purpose of highly doped portions 24a and 26a are to reduce resistivity and achieve high bandwidth performance.

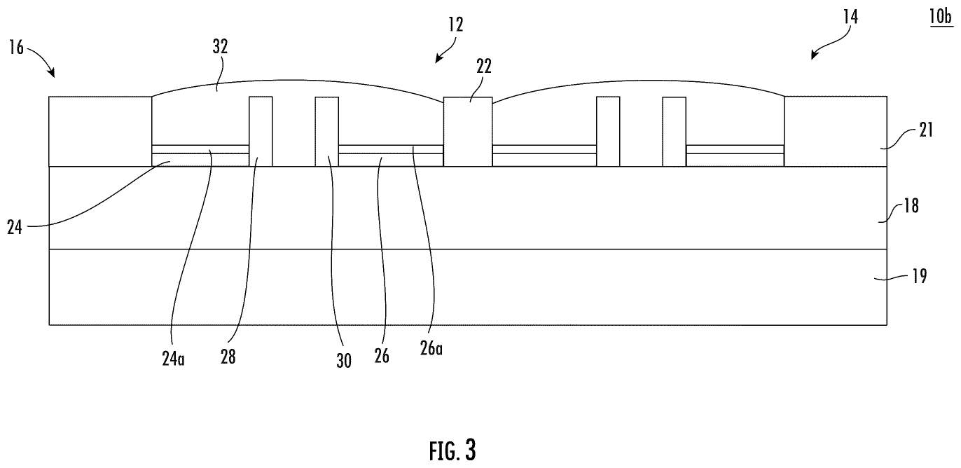

Turning to FIG. 3, a slot modulator 10b is illustrated in which slabs 24 and 26 are partially replaced with highly doped silicon layers 24a and 26a deposited on the upper surface. Layer 24a extends from contact with G conductor 20 at one edge to contact with rail 28 at the other edge. Layer 26a extends from contact with s conductor 22 at one edge to contact with rail 30 at the other edge. The combined thickness of slab 24 and silicon layer 24a is the same as the thickness of slab 24 prior to the replacement. Thus, the thickness of the metal of slab 24 adjacent rail 28 is reduced. The combination of slab 26 and layer 26a is similar. The extension of metal towards rails with Si high doping improves rf performance and achieves a higher bandwidth.

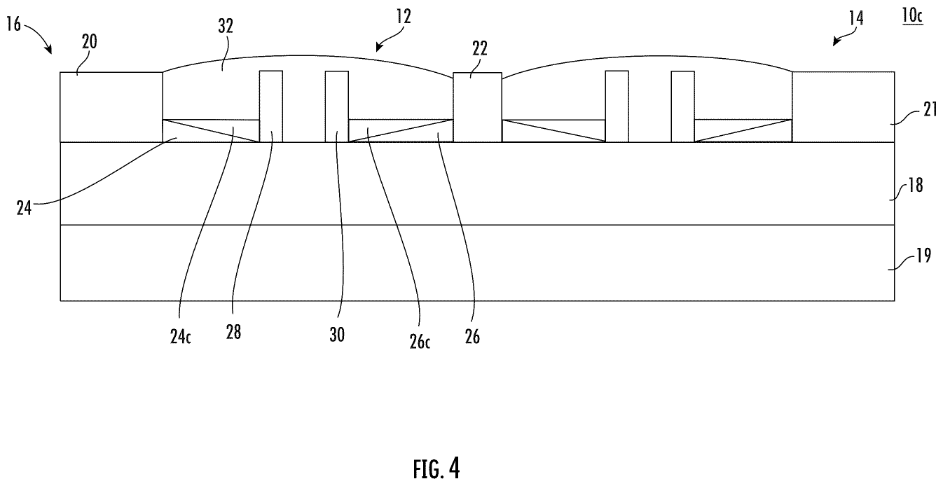

Turning to FIG. 4, a slot modulator 10c is illustrated in which the metal profiles of slabs 24 and 26 are shaped with highly doped silicon portions 24c and 26c replacing similar portions of slabs 24 and 26, respectively. In this specific embodiment layer 24c has a generally triangularly shaped cross-section that extends from adjacent G conductor 20 to contact with rail 28. Silicon portion 24c extends the full thickness of slab 24 adjacent rail 28. Similarly, silicon portion 26c is a mirror image of silicon portion 24c. This extension of the metal towards the rails reduces the resistivity of the overall slab and achieves a higher bandwidth while the profile shaping in metal thickness prevents the metal from reaching the optical mode in the slot waveguide hence increasing the optical loss. While the example illustrated in FIG. 4 shows a triangular shape, it should be understood that the shape could be asymptotical, such as curved or staircase shaped.

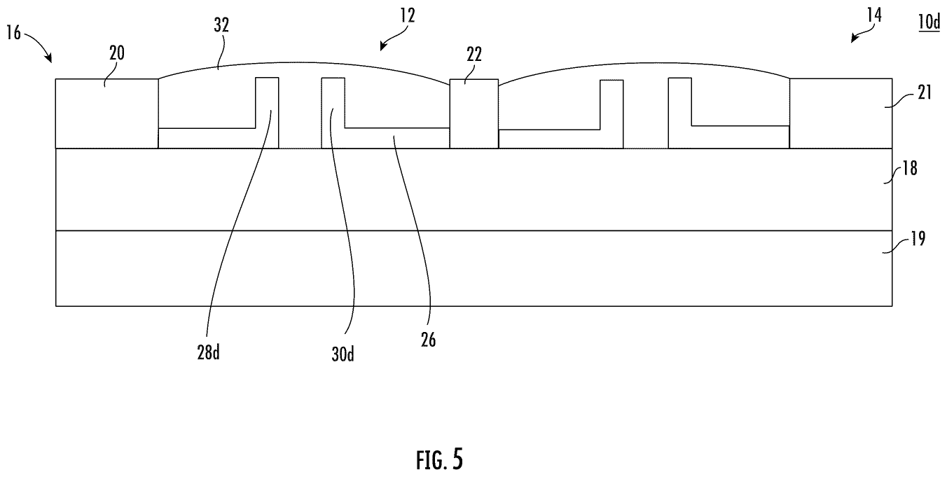

Turning to FIG. 5, a slot modulator 10d is illustrated in which the doping of rails 28d and 30d are modulated to gradually change the amount of doping. In this example the doping of rails 28d and 30d is gradually changed from an N⁺ doping adjacent the bottom to an N⁺⁺⁺ adjacent the upper end. This modulation doping is selected and designed to increase rf performance and to achieve high bandwidth.

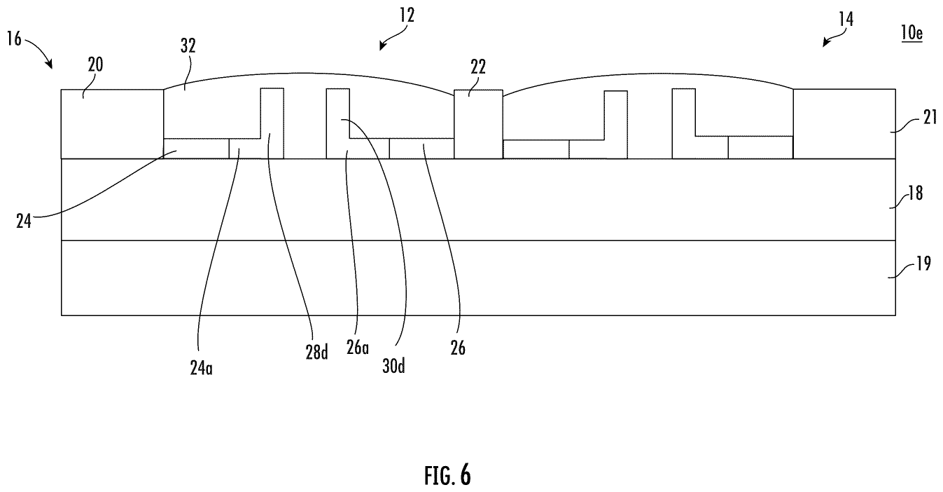

Turning to FIG. 6, a slot modulator 10e is illustrated that is a combination of the modifications describe in conjunction with modulator 10b in FIG. 2 and modulator 10d in FIG. 5. That is slabs 24 and 26 are partially replaced with portions 24a and 26a respectively. Also, the doping of rails 28 and 30 is gradually changed from an N⁺ doping adjacent the bottom to an N⁺⁺⁺ adjacent the upper end as described in conjunction with modulator 10d in FIG. 5.

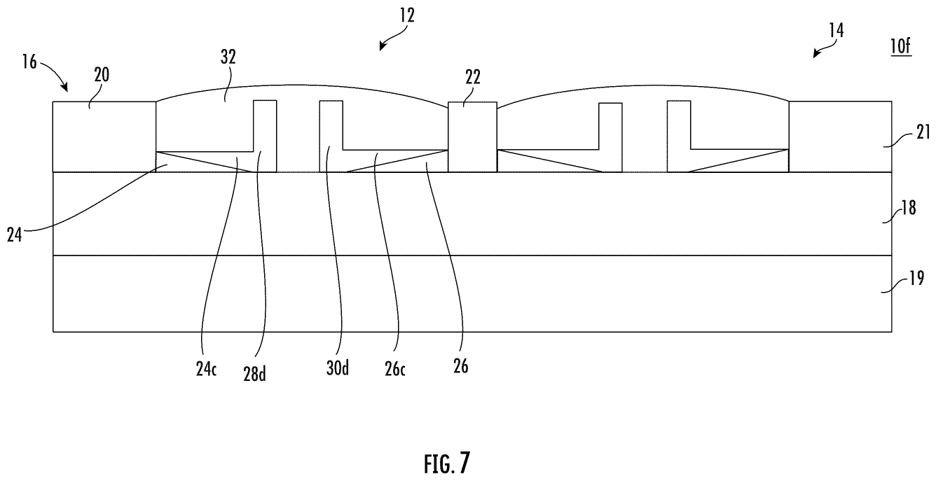

Turning to FIG. 7, a slot modulator 10f is illustrated that is a combination of the modifications describe in conjunction with modulator 10c in FIG. 4 and modulator 10d in FIG. 5. That is the metal profiles of slabs 24 and 26 are shaped with highly doped silicon portions 24c and 26c replacing similar portions of slabs 24 and 26, respectively, as described in conjunction with modulator 10c in FIG. 4. Also, the doping of rails 28d and 30d is gradually changed from an N⁺ doping adjacent the bottom to an N⁺⁺⁺ adjacent the upper end as described in conjunction with modulator 10d in FIG. 5.

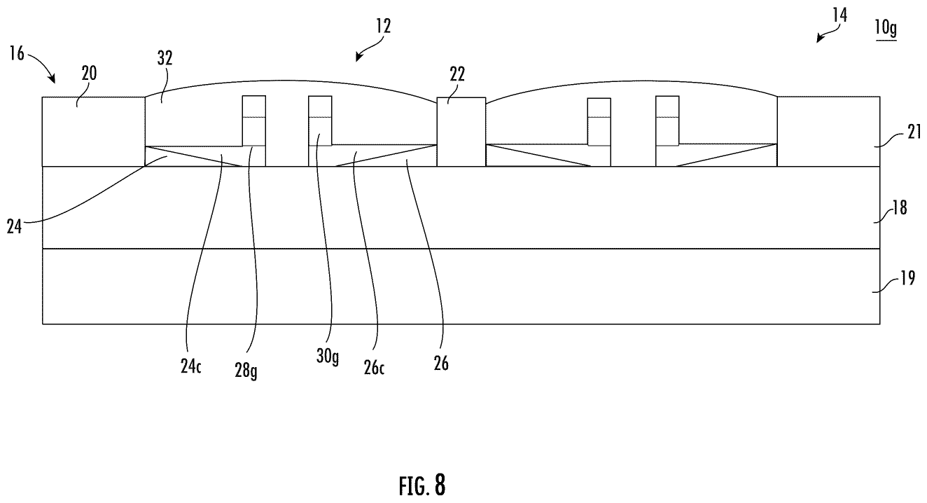

Turning to FIG. 8, a slot modulator 10g is illustrated that is a combination of the modification describe in conjunction with modulator 10c in FIG. 4 and further varying doping of rails 28 and 30. That is the metal profiles of slabs 24 and 26 are shaped with highly doped silicon portions 24c and 26c replacing similar portions of slabs 24 and 26, respectively, as described in conjunction with modulator 10c in FIG. 4. Also, the doping of rails 28g and 30g is varied throughout their height that is, changed between an N⁺ doping adjacent the bottom and the upper end to and an N⁺⁺⁺ area approximately centrally located. The main concept here is to achieve an improved rf performance and a high bandwidth.

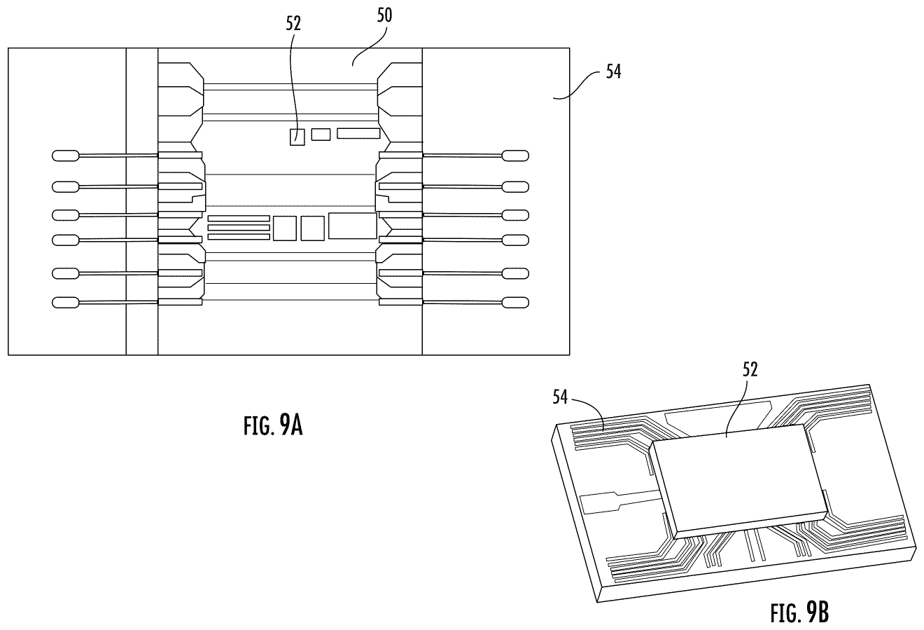

Turning now to FIG. 9A, a top plan view of a semiconductor chip 50 with multiple Mach-Zehnder slot modulators 52 (three in this example). Semiconductor chip 50 is mounted on a printed circuit board 54 and slot modulators 52 are electrically connected to external circuitry on printed circuit board 54 by means of wire bonds to illustrate the difficulty of such connections. RF pads with wire bonding must be close to the edges of semiconductor chip 50 to improve rf performance. However, chip foundries have a limit on chip size (>3 mm) and slot modulators are so tiny they do not approach the chip edges.

As illustrated in FIG. 9B, to overcome this problem slot modulator chip 52 is inverted and mounted up-side-down on printed circuit board 54 so that direct electrical connections are made to circuitry arranged on printed circuit board 54 to receive the flip-chip. Thus, improved rf performance and a high bandwidth are achieved while simplifying the interconnection process.

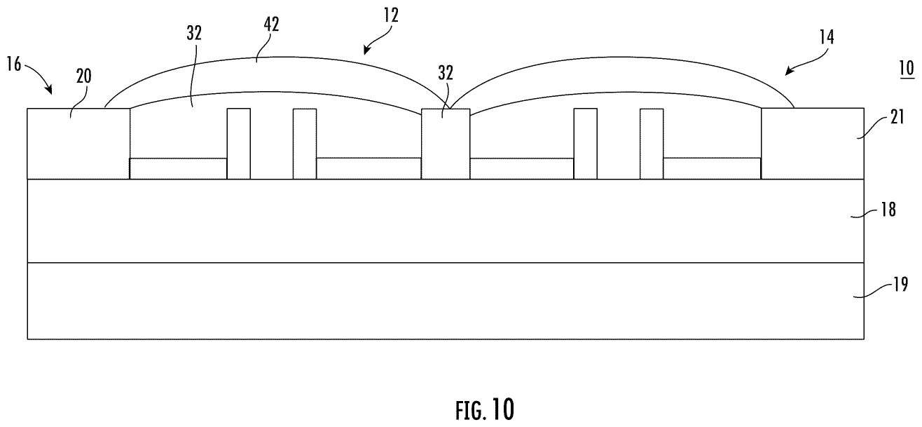

Turning now to FIG. 10 a slot modulator is illustrated, which in this specific embodiment is slot modulator 10 from FIG. 1. The EO polymer portions 32 of slot modulator 10 are covered with encapsulation layers 42. In a preferred example of encapsulation layer 42, aluminum oxide (AlₓO_{y}) is deposited using ALD (atomic layer deposition), which can seal the polymer and chromophores from at least oxygen (this is the killer specie) to greater than 99%. One of the characteristics of the ALD process is that it is self-limiting in its deposition process and, therefore, is a high quality sealant. In practice, encapsulation layer 42 can include any of the examples: a super lattice design using ALD; combinations of more than one oxide (e.g. 2 oxides or three oxides); combinations of oxide and nitride, or two oxides and one nitride, or two nitrides and one oxide; and use of aluminum oxide and other oxides such as titanium oxide.

Thus, new and improved slot modulators with improved RF and bandwidth performance have been disclosed. Also, new and improved slot modulators in a Mach-Zehnder configuration with improved rf and bandwidth performance have been disclosed. Basically, the electrical connections to the rails forming the slot are modified from the metal prior art slabs to silicon slabs that are highly doped and/or with shaped profiles. Also, the rails are formed of highly doped silicon which may be modulated to vary the doping across the length of the rails. The main concept here is to achieve an improved rf performance and a high bandwidth.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A slot modulator coupled to a coplanar transmission line, the slot modulator comprising:
a pair of spaced apart rails forming a waveguide slot therebetween and opposed slabs coupling the rails to the coplanar transmission line, the rails being formed of highly doped silicon, the pair of rails each extend vertically upwardly in parallel from a lower surface positioned on a substrate to an upper end;
the highly doped silicon forming the pair of rails varies between N⁺ and N⁺⁺⁺ between the lower surface and the upper end; and
the slabs being formed at least partially of highly doped silicon.

2. (canceled)

3. (canceled)

4. The slot modulator claimed in claim 1 wherein the at least partial amount of highly doped silicon forming the slabs is approximately 50% to 100% of each slab.

5. The slot modulator claimed in claim 1 wherein the highly doped silicon at least partially forming the slabs includes a layer positioned on an upper surface of each of the slabs.

6. The slot modulator claimed in claim 1 wherein the highly doped silicon at least partially forming the slabs includes a portion of the width of each slab.

7. The slot modulator claimed in claim 1 wherein the highly doped silicon at least partially forming the slabs is profiled along the width of each slab.

8. The slot modulator claimed in claim 1 wherein the highly doped silicon at least partially forming the slabs is profiled along the width of each slab so that only highly doped silicon is in contact with the rails.

9. A Mach-Zehnder slot modulator coupled to a coplanar transmission line, the slot modulator comprising:
a substrate;
the coplanar transmission line positioned on the substrate and including first and second spaced apart elongated conductors with a third elongated conductor positioned midway between the first and second conductors;
a first pair of spaced apart rails positioned on the substrate between the first elongated conductor and the third elongated conductor and a second pair of spaced apart rails positioned on the substrate between the second elongated conductor and the third elongated conductor, the first and second pairs of spaced apart rails each forming an elongated waveguide slot therebetween, the rails being formed of highly doped silicon, the first and second pairs of rails each extend vertically upwardly in parallel from a lower surface positioned on the substrate to an upper end;
the highly doped silicon forming the pairs of rails varies from N⁺ to N⁺⁺⁺ between the lower surface and the upper end;
opposed slabs positioned on the substrate and coupling first and second pairs of rails to the elongated the conductors of the coplanar transmission line, the slabs being at least partially formed of highly doped silicon; and
EO polymer cladding material deposited over the first and second pairs of spaced apart rails and the slabs between the elongated conductors and in the waveguide slots.

10. (canceled)

11. (canceled)

12. The Mach-Zehnder slot modulator claimed in claim 9 wherein the at least partial amount of highly doped silicon forming the slabs is approximately 50% to 100% of each slab.

13. The Mach-Zehnder slot modulator claimed in claim 9 wherein the highly doped silicon at least partially forming the slabs includes a layer positioned on an upper surface of each of the slabs.

14. The Mach-Zehnder slot modulator claimed in claim 9 wherein the highly doped silicon at least partially forming the slabs includes a portion of the width of each slab.

15. The Mach-Zehnder slot modulator claimed in claim 9 wherein the highly doped silicon at least partially forming the slabs is profiled along the width of each slab.

16. The Mach-Zehnder slot modulator claimed in claim 15 wherein the highly doped silicon at least partially forming the slabs is profiled along the width of each slab so that only highly doped silicon is in contact with the rails.

17. The Mach-Zehnder slot modulator claimed in claim 9 wherein the EO polymer cladding material is encapsulated with a passivation layer.

18. A method of fabricating a slot modulator coupled to a coplanar transmission line, the method comprising the steps of:
providing a substrate with the coplanar transmission line thereon, the coplanar transmission line including at least one pair of spaced apart conductors;
forming a pair of spaced apart elongated rails on the substrate between the pair of spaced apart conductors, the spaced apart an elongated waveguide slot therebetween, the rails being formed of highly doped silicon, the pair of rails each extend vertically upwardly in parallel from a lower surface positioned on the substrate to an upper end;
the highly doped silicon forming the pair of rails varies from N⁺ to N⁺⁺⁺ between the lower surface and the upper end;
forming opposed slabs on the substrate coupling the rails to the spaced apart conductors of the coplanar transmission line, the slabs being formed at least partially of highly doped silicon; and
depositing an EO polymer cladding layer over the slabs and rails and in the waveguide slot.

19. The method as claimed in claim 18 further including the step of encapsulating the polymer cladding layer with a passivation layer.

20. The method as claimed in claim 19 wherein the step of encapsulating the polymer cladding layer with the passivation layer includes depositing the passivation layer by atomic layer deposition.
